(19) United States
(12) Patent Application Publication
(10) Pub. No.: US 2013/0091422 A1
(43) Pub. Date: Apr. 11, 2013

(54) System and Method for Dynamically Creating a Document Using a Template Tree

(71) Applicants: Gururaj Potnis, Bangalore (IN); Mohit Kataria, Bangalore (IN)

(72) Inventors: Gururaj Potnis, Bangalore (IN); Mohit Kataria, Bangalore (IN)

(21) Appl. No.: 13/405,430

(22) Filed: Feb. 27, 2012

(30) Foreign Application Priority Data
Oct. 10, 2011 (IN) 3479/CHE/2011

(51) Int. Cl. G06F 17/22

(52) U.S. Cl. 715/255

(57) ABSTRACT

A document creation tool for dynamically generating a document that is specific to a context using a template tree of that document type. The document creation tool includes a database that stores templates of various document types, each of the templates includes a set of alternative clauses and alternative sub-clauses. A processing module processes a mere selection a template having a template tree that includes a set of the alternative clauses and alternative sub-clauses, and a mere selection of a sub-set of a plurality of alternative clauses and alternative sub-clauses from the set of the alternative clauses and alternative sub-clauses based on a corresponding text and metadata associated with the sub-set of the alternative clauses and the alternative sub-clauses. A document creation module generates the document that is specific to the context based on the corresponding text and metadata of the sub-set of the alternative clauses and alternative sub-clauses.

### BACKGROUND

1. Technical Field

The embodiments herein generally relate to document creation, and more particularly to a system and method for dynamically creating documents specific to a context using a template tree of that document type and updating a library associated with a document creation tool as and when new versions of one or more alternative clauses and/or sub-clauses are formed while creating the documents of that document type.

2. Description of the Related Art

Small and large business entities generate several documents like contracts, proposals, correspondence etc. to serve business purposes and capture communication/understanding with customers, vendors, partners, other entities or internal audience. Typically, the text and import of each document in relation to engagement vary with the intended purpose and the context of each document. Document creation relies heavily of human memory and past experience of the author who creates the document.

Typically, a new document in a business scenario is created using templates from a library or from previous such documents that were created in similar contexts. For instance, to draft a “Service Purchase Agreement”, typically a user starts creating the intended document by choosing a standard template which has been pre-stored as a template file in either a document management system or otherwise stored in folders in one or more formats.

Alternatively, the user chooses a “Service Purchase Agreement” draft that was previously drafted for another counter-party as the starting point. Hence the author may have several templates, any of which can be the starting point. Using one such Service Purchase Agreement template draft, the user will customize the content based on his/her judgment to suit the current context. This judgment is based on the implications inferred by reading the text. However, the entire process of knowing where to start and specifically which template is to be used to begin the drafting process is a factor of knowledge and experience of the author who drafts the document.

Each template corresponds to its own context when it was prepared and will be required to be changed to suit the current context. For example, a typical template may have one or more clauses and corresponding one or more sub-clauses. Any chosen template will require modification, deletion, replacement with apt text, and/or addition of new text to the existing clauses and sub-clauses. While performing above actions to the existing clauses and/or sub-clauses within a chosen template, it may lead to forming one or more new versions of clauses and/or sub-clauses.

The conventional document creation tools do not have the ability to update the clause library and store new versions of clauses and/or sub-clauses in the library as and when they are formed. This is due to the fact that such tools are typically populated with frozen template documents. Once a template is fed into the system, subsequent changes or evolution of better versions of clauses and sub-clauses do not add back to the templates dynamically. Authors are required to begin with the same base template document for every new requirement for the creation of documents of a particular document type. Because of this inefficiency, users continue to use standard base templates and modify those as required for the context, but this entails extensive manual intervention to complete every document. This makes context specific document creation a costly process, requiring substantial human intervention and also may result in loss of relevant information. Accordingly there remains a need for a document creation tool that allows creating documents specific to a context using an extensive template tree of that document type.

### SUMMARY

In view of the foregoing, an embodiment herein provides a method for generating a document of a specific document type that includes a plurality of sections that are specific to a context using a template tree of the specific document type without loss of relevant information while ensuring accuracy and standards to suit said context. The document is generated using a document creation tool that includes a database that stores a plurality of templates of different document types. Each of the templates includes a set of a plurality of alternative clauses and a plurality of alternative sub-clauses that are arranged hierarchically. The method includes displaying the plurality of templates of different document types already stored on the database, processing a first input that includes a mere selection of at least one template from the plurality of templates, displaying a template tree that corresponds to the selected template. The template tree includes of a set of the plurality of alternative clauses and the plurality of alternative sub-clauses stored on the database. The method further includes processing a second input that includes a mere selection of a sub-set of a plurality of alternative clauses and alternative sub-clauses from the set of the plurality of alternative clauses and the plurality of alternative sub-clauses. The sub-set of the alternative clauses and the alternative sub-clauses are selected based on a corresponding text and metadata associated with the sub-set of the alternative clauses and the alternative sub-clauses. The document is created based on the corresponding text and the metadata of the sub-set of the alternative clauses and the alternative sub-clauses. The created document includes the sections that are specific to the context.

The method further includes updating the template tree and the database when at least one of alternative clauses or alternative sub-clauses are formed on the document being created, or when at least one of alternative clauses, or alternative sub-clauses are extracted from various documents of that document type. The metadata is a subjective qualification or an objective qualification of the text. The document is any of (i) a contract, (ii) agreements. The agreements may be any of a Non-disclosure agreement, a Service purchase agreement, a Goods purchase agreement, a Franchisee agreement, a Partnership agreement, or an Employee Union agreement, or any other document that is created using (a) a precedent document of that document type or (b) a predefined document that comprises of set of clauses or sub clauses.

The template tree for a particular document type consists of text and metadata from various documents of that type and is segregated hierarchically such as a first level, a second level, and a third level. The second level is linked to the first level, and the third level is linked to the second level. Each of the alternative clauses, each of the alternative sub-clauses, or each of the sub-sub clauses serve as an alternate starting point for a user to draft a particular sections in the template tree of the document.

In another aspect, a document creation tool that dynamically generates a using a template tree of that document type without loss of relevant information while ensuring accuracy and standards to suit the context is provided. The document includes a plurality of sections that are specific to the context. The document creation tool includes a database that stores a plurality of templates of different document types. Each of the templates includes a set of a plurality of alternative clauses and a plurality of alternative sub-clauses. A display module displays the plurality of templates of different document types already stored on the database.

A processing module processes a first input including a mere selection of at least one template from the plurality of templates. A template tree that corresponds to the at least one template is displayed based on the mere selection. The template tree includes of a set of the plurality of alternative clauses and the plurality of alternative sub-clauses stored on the database. The processing module further processes a second input including a mere selection of a sub-set of a plurality of alternative clauses and alternative sub-clauses from the set of the plurality of alternative clauses and the plurality of alternative sub-clauses. The sub-set of the alternative clauses and the alternative sub-clauses are selected based on a corresponding text and metadata associated with the sub-set of the alternative clauses and the alternative sub-clauses. A document creation module generates the document based on the corresponding text and the metadata of the sub-set of the alternative clauses and the alternative sub-clauses. The document that is created includes the sections that are specific to the context.

The document creation tool further includes an update module that updates the template tree and the database when at least one of alternative clauses or alternative sub-clauses are formed on the document being created, or when at least one of alternative clauses or alternative sub-clauses are extracted from various documents of that document type. The template tree for a particular document type consists of the text from various documents of that type and is segregated hierarchically such as a first level, a second level, and a third level. The second level is linked to the first level. The third level is linked to the second level.

In yet another aspect, a non-transitory program storage device readable by computer, and having a program of instructions executable by the computer to perform a method of dynamically creating a document that includes a plurality of sections that are specific to a context using a template tree of that document type without loss of relevant information while ensuring accuracy and standards to suit the context is provided. The document is created using a document creation tool. The document creation tool includes a database that stores a plurality of templates of different document types. Each of the templates includes a set of a plurality of alternative clauses and a plurality of alternative sub-clauses that are arranged hierarchically.

The method includes processing a first input that includes a mere selection of at least one template from the plurality of templates, displaying a template tree that corresponds to the at least one template based on the mere selection. The template tree includes of a set of the plurality of alternative clauses and the plurality of alternative sub-clauses stored on the database. The method further includes processing a second input that includes a mere selection of a sub-set of a plurality of alternative clauses and alternative sub-clauses from the set of the plurality of alternative clauses and the plurality of alternative sub-clauses. The sub-set of the alternative clauses and the alternative sub-clauses are selected based on a corresponding text and metadata associated with the sub-set of the alternative clauses and the alternative sub-clauses. The document is created based on the corresponding text and the metadata of the sub-set of the alternative clauses and the alternative sub-clauses. The created document includes the sections that are specific to the context.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view of a user communicating with a intelligence encoded high speed document creation system to generate a document for a particular context using a document creation tool according to an embodiment herein;

FIG. 2 illustrates an exploded view of the document creation tool of FIG. 1 according to an embodiment herein;

FIG. 3 illustrates a user interface view of a document template as a tree according to an embodiment herein;

FIG. 4 illustrates a user interface view of a clause as a tree according to an embodiment herein;

FIG. 5A and FIG. 5B illustrates a user interface view of the document creation tool of FIG. 1 in a drafting mode according to an embodiment herein;

FIG. 6A and FIG. 6B illustrates a user interface view of the document creation tool of FIG. 1 in a template building mode according to an embodiment herein;

FIG. 7A illustrates a user interface view of the document creation tool of FIG. 1 having only one version of clause according to an embodiment herein;

FIG. 7B illustrates a user interface view of the document creation tool of FIG. 1 having only more than one alternative (e.g., competing) versions of clauses according to an embodiment herein;

FIG. 8 is a table view illustrating type of metadata for a template tree according to an embodiment herein;

FIG. 9 is a table view illustrating type of metadata for alternative (e.g., competing versions) clauses, and alternative sub-clauses according to an embodiment herein;

FIG. 10 is a flow diagram illustrating a method of dynamically creating at least one document a specific document type using a document creation tool of FIG. 1 according to an embodiment herein; and

FIG. 11 illustrates a schematic diagram of a computer architecture according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

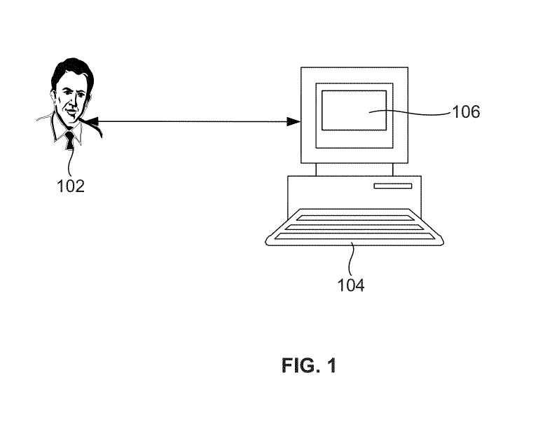

As mentioned, there remains a need for a document creation tool that allows creating documents using a template tree without loss of relevant information while ensuring accuracy and standards to suite the current context. The embodiments herein achieve this by providing the document creation tool that allows creating documents that are specific to a context using a template tree of that document type without loss of relevant information. This further ensures accuracy and standards by better construction of the document template to suit the current context. The document creation tool 106 further updates the template tree and the database 202 as and when new versions of one or more alternative clauses and/or sub-clauses are formed while creating the document for that document type. The template tree is extensive and consists of an exhaustive set of clauses and sub-clauses for a document type. In addition, each clause or sub-clause will have several alternative versions, each of which may be relevant for a specific context. Hence the template tree of a document type will be an exhaustive set of possibilities of constructing a document. The template tree will keep on evolving into a more expansive tree when new versions of clauses and/or sub-clauses are formed in the course of creating documents of that document type and are added back to enrich the template tree. Thus, the document that is created includes one or more sections based on text and metadata of a sub-set of the alternative clauses and the alternative sub-clauses that are selected from a plurality of the alternative clauses and the alternative sub-clauses. Referring now to the drawings, and more particularly to FIGS. 1 through 11, where similar reference characters denote corresponding features consistently throughout the figures, there are shown preferred embodiments.

FIG. 1 illustrates a system view of a user 102 communicating with an intelligence encoded high speed document creation system 104 to generate a document for a particular context using a document creation tool 106 according to an embodiment herein. The document creation tool 106 includes a database (not shown in FIG. 1) that includes one or more libraries for storing one or more alternative (e.g., competing versions) clauses, one or more alternative sub-clauses, and one or more alternative sub-sub-clauses, and one or more templates each having at least one template tree.

The document creation tool 106 provides a user interface to the user 102 to dynamically create one or more documents specific to a context using a template tree of that document type and updates a library as and when new versions of one or more alternative clauses and/or sub-clauses are formed while creating the documents of that document type using a template tree.

The template tree for a particular document type consists of text from various documents of that type and is segregated hierarchically as clauses and sub-clauses, and the smallest level constituent having one or more alternative (e.g., competing) versions. The document includes one or more sections, each section corresponds to one or more alternative clauses, and corresponding alternative sub-clause. The document that is created using the template tree may be any of (i) a contract, or (ii) agreements such as a Non-disclosure agreement, a Service purchase agreement, a Goods purchase agreement, a Franchisee agreement, a Partnership agreement, and/or an Employee Union agreement, etc. In one embodiment, the document may be created using (a) a precedent document of that document type or (b) a predefined document that includes set of clauses or sub clauses.

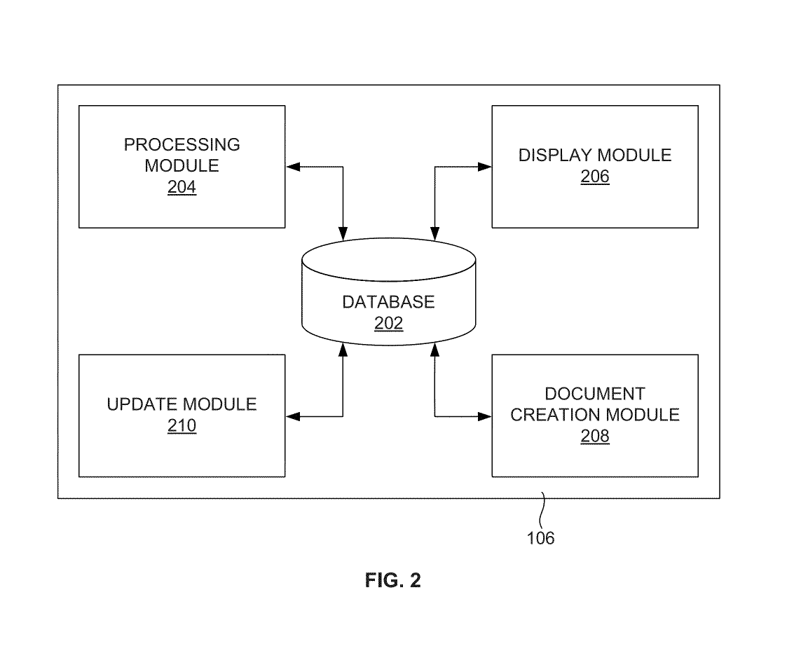

FIG. 2 illustrates an exploded view of the document creation tool 106 of FIG. 1 according to an embodiment herein. The document creation tool 106 includes a database 202, a processing module 204, a display module 206, a document creation module 208, and an updating module 210. The database 202 stores a plurality of templates of different document types. Each of the templates includes a set of a plurality of alternative clauses and alternative sub-clauses.

The display module 206 displays the plurality of templates of different document types already stored on the database 202. The processing module 204 processes a first input including a mere selection of at least one template from the plurality of templates. In one embodiment, a mere selection of the at least one template is a selection of a pre-defined template where the user 102 creating a document does not have to type any text in the template. The template tree corresponds to the at least one template is displayed based on the mere selection (e.g., by the display module 206). The template tree includes a set of the plurality of alternative clauses and the plurality of alternative sub-clauses. The processing module 204 further processes a second input including a mere selection of a sub-set of a plurality of alternative clauses and alternative sub-clauses from the set of the plurality of alternative clauses and the plurality of alternative sub-clauses within the same template tree. The sub-set of the alternative clauses and the alternative sub-clauses are selected based on a corresponding text and metadata associated with the sub-set of the alternative clauses and the alternative sub-clauses. In one embodiment, the metadata is a subjective qualification or an objective qualification of the text.

The document creation module 208 generates the document that includes one or more sections that are specific to the context based on the text and the metadata of the sub-set of the alternative clauses and the alternative sub-clauses. The update module 210 updates the template tree and/or the database 202 when at least one alternative clauses or alternative sub-clauses are formed on the document being created. In one embodiment, the update module 210 updates the template tree and/or the database 202 when at least one of alternative clauses or alternative sub-clauses are extracted from various documents of that document type.

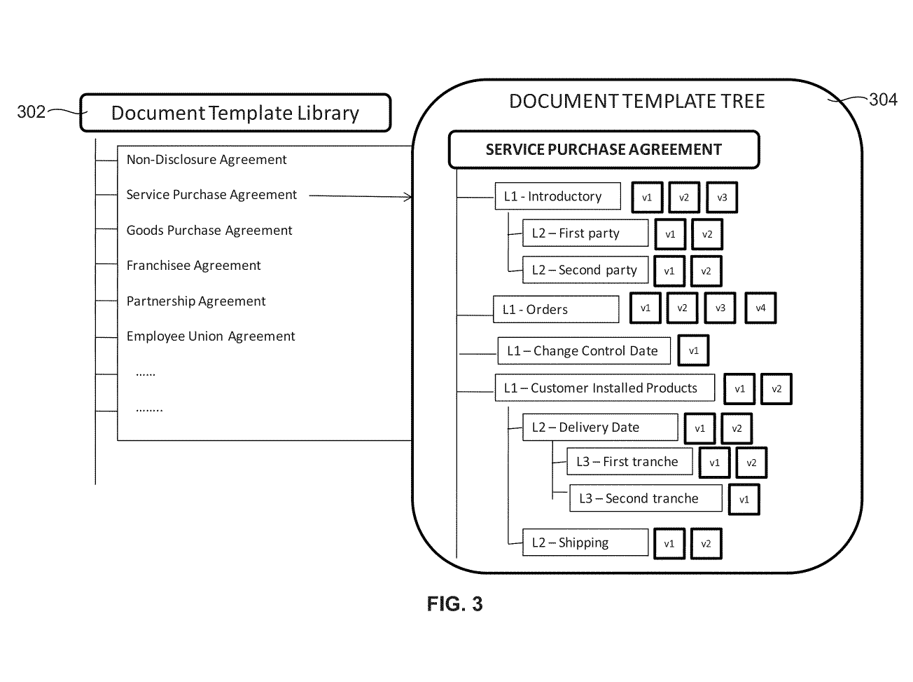

FIG. 3 illustrates a user interface view of a document template as a tree according to an embodiment herein. The user interface view includes a document template library 302, and a document template tree 304. As shown in FIG. 3, the document template library 302 may includes one or more document templates such as a Non-disclosure agreement, a Service purchase agreement, a Goods purchase agreement, a Franchisee agreement, a Partnership agreement, and/or an Employee Union agreement, etc. For example, a document template tree 304 for the Service purchase agreement is illustrated as shown in FIG. 3.

The document template tree 304 for the Service purchase agreement may include one or more levels such as L1, L2, and/or L3, etc. In one embodiment, the level L1 correspond to one or more clauses, the level L2 correspond to one or more sub-clauses and the level L3 correspond to one or more sub-sub-clauses. For example the level L1 that corresponds to a clause title “introductory” has 3 alternative (e.g., competing) versions of text (e.g., v1, v2, v3, etc.). Each of the versions can serve as an alternate starting point for the user 102 to draft a particular “introductory” component in a document.

The components are meshed in top-down hierarchical levels. The template tree contains an exhaustive set of components that will fall under one or several contexts of the document type. Hence for each of the document type, only one tree template is built. In the example as shown in the FIG. 3, a single “Service Purchase Agreement” tree is built by adding exhaustively all components from several Service Purchase Agreements each of which were prepared in specific contexts.

As shown in FIG. 3, the level L1 refers to main clauses of a document. The level L2 will be at the sub-clause level and is linked to a unique parent clause of the L1 level. The level L3 will at the sub-sub-clause level and is linked to a unique parent clause of the L2 level. All version of a document component will be at the same level. For example, in the document template tree, the two alternative (e.g., competing) versions of text for “Delivery Date” will be at the L2 level, and linked uniquely to the clause “Customer Installed Products” which is at the L1 level.

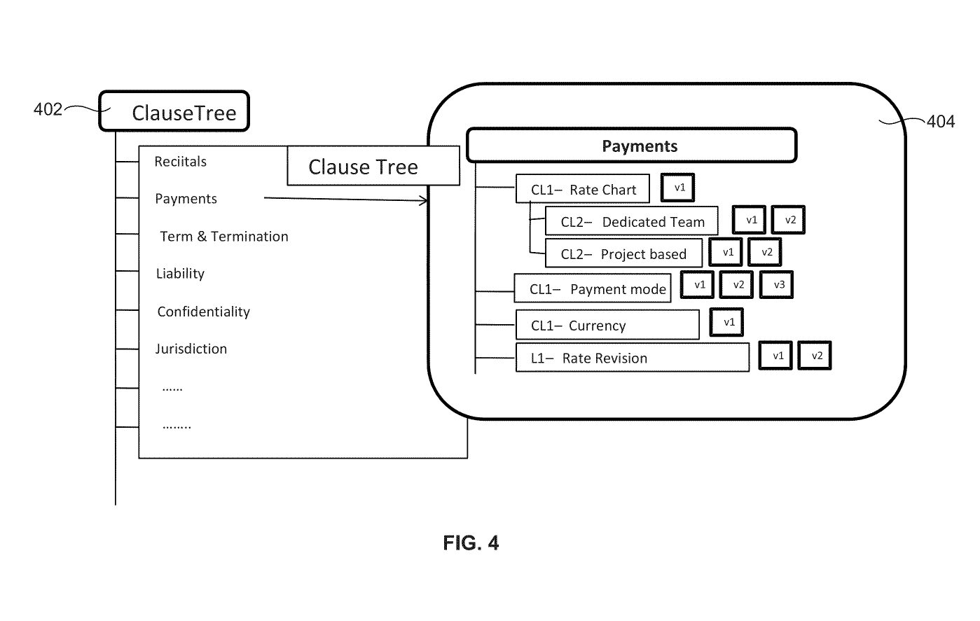

FIG. 4 illustrates a user interface view of a clause as a tree according to an embodiment herein. The user interface view includes a clause tree 402, and a clause title 404. The clause tree 402 may include one or more clause titles such as Recitals, Payments, Terms & Termination, Liability, Confidentiality, and/or Jurisdiction, etc. As shown in FIG. 4, the clause title 404 “Payments” may include one or more clause and sub-clauses levels such as CL1, CL2, etc. CL1 corresponds to clause level, and CL2 corresponds to sub-clause level.

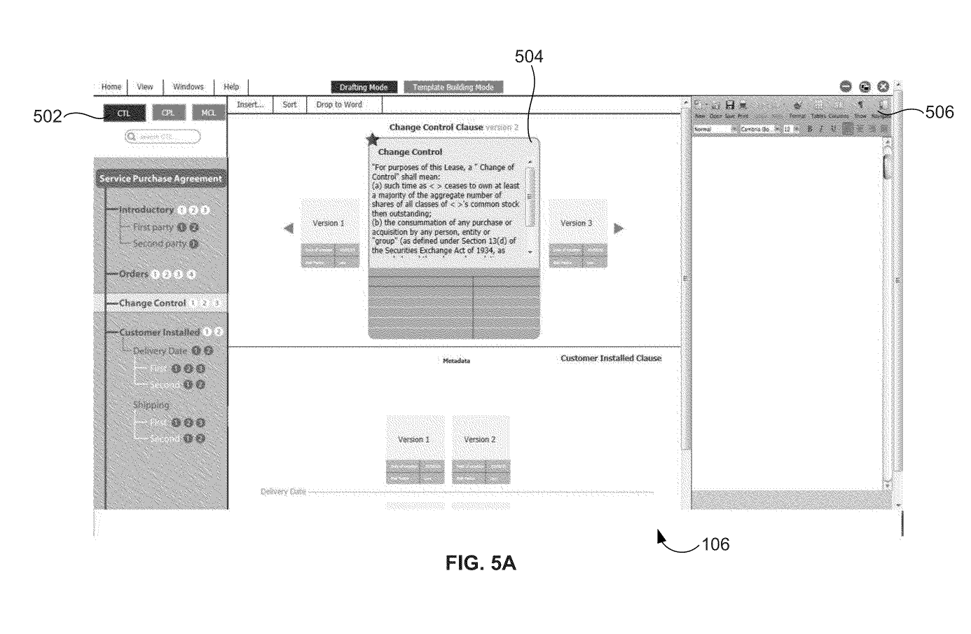

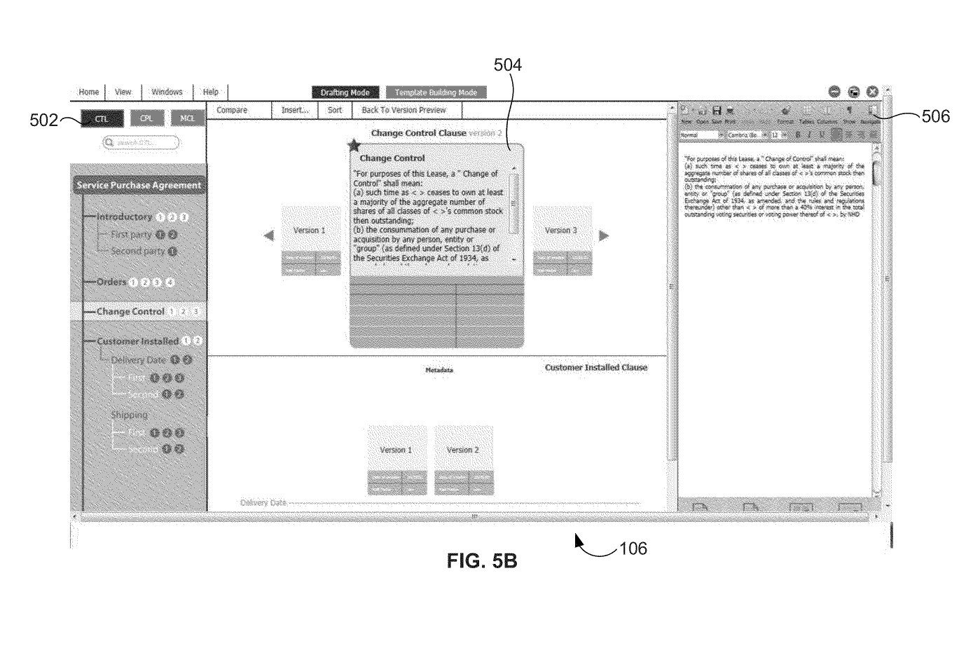

FIG. 5A and FIG. 5B illustrates a user interface view of the document creation tool 106 of FIG. 1 in a drafting mode according to an embodiment herein. The user interface view of the document creation tool 106 includes a contract template library field 502, a change control clause field 504, and a word processing field 506. The contract template library 502 includes one or more contract or document creation templates. Each of the templates includes one or more alternative clauses, and one or more alternative (e.g., competing) sub-clauses corresponding to at least one of the alternative clauses.

The user 102 may load a file into the word processing field 506 by using a drop to word option and select text and drop into the change control clause field 504. The user 102 may then save a version of a clause or sub-clause corresponding to the clause by clicking on a save option. The user may also add metadata to each of the clause and/or alternative (e.g., competing) versions of sub-clauses corresponding to the clause. The metadata may include such as date of creation, and/or risk factor, etc.

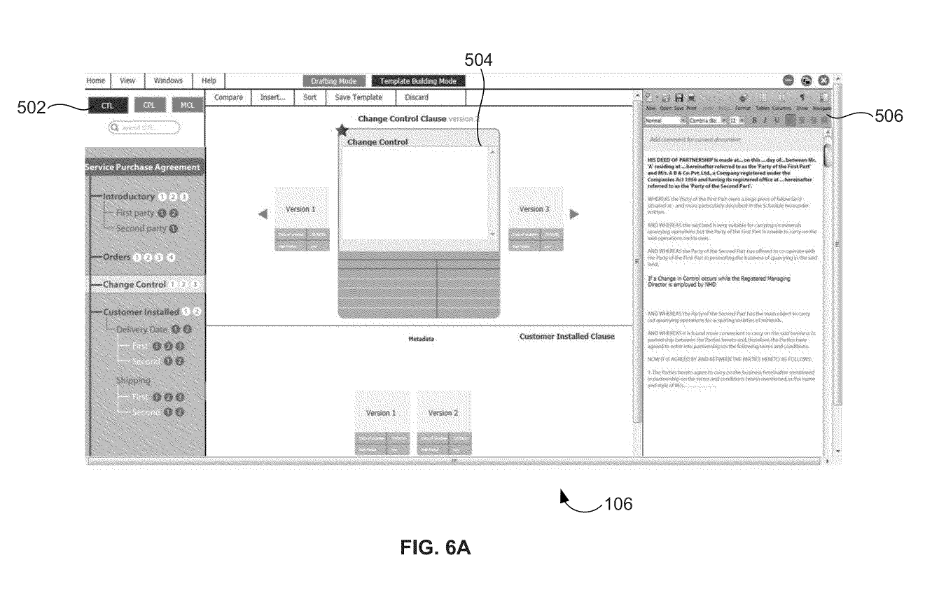

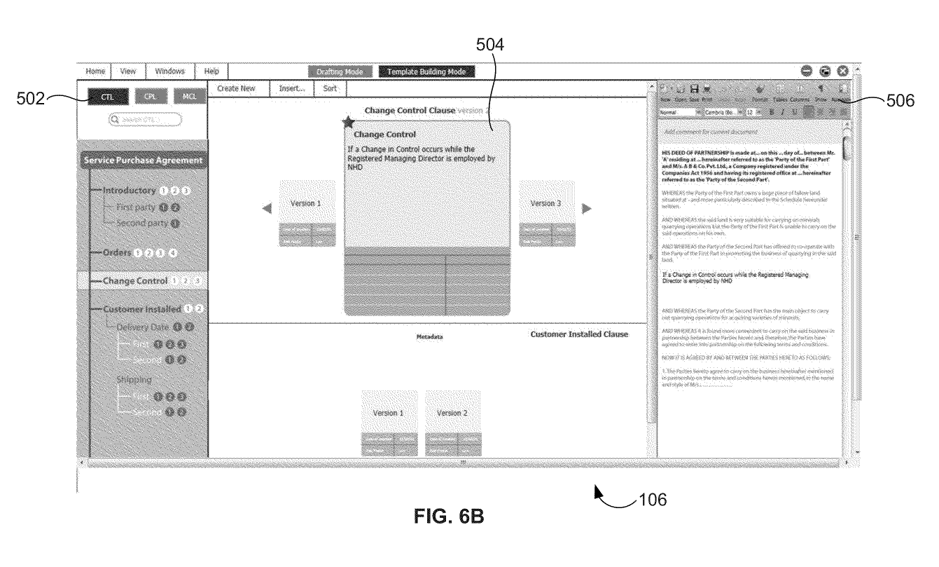

With reference to FIG. 5A and FIG. 5B, FIG. 6A and FIG. 6B illustrates a user interface view of the document creation tool 106 of FIG. 1 in a template building mode according to an embodiment herein. As shown in FIG. 6A, similarly, the user 102 can create a template in the template building mode and save the template in the contract template library 502. The user 102 may edit the content of the template using the word processing field 506. The template that is created is based on a sub-set of the set of the plurality of alternative clauses and alternative sub-clauses and are selected based on corresponding text and metadata associated with the sub-set of the set of the plurality of alternative clauses and alternative sub-clauses.

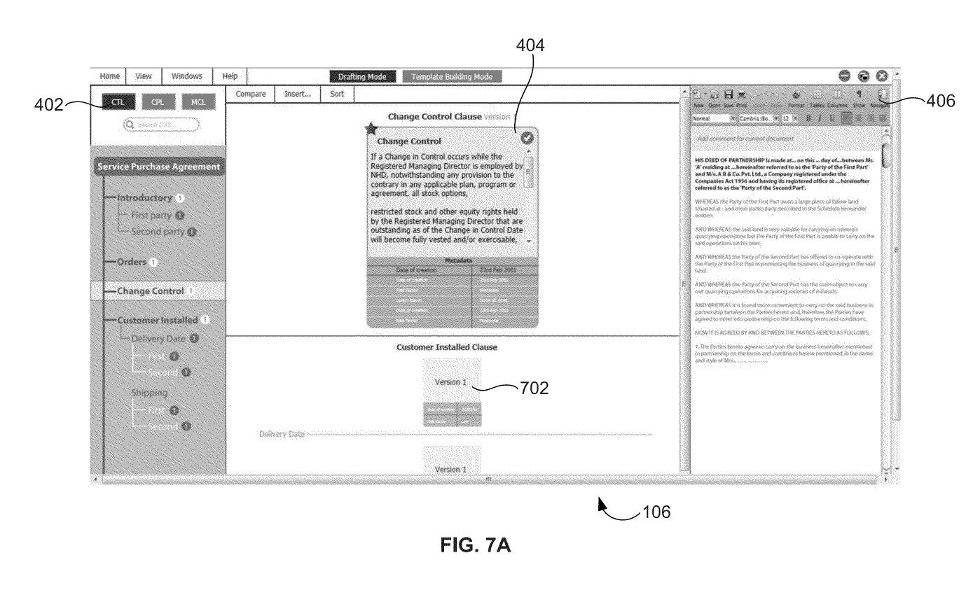

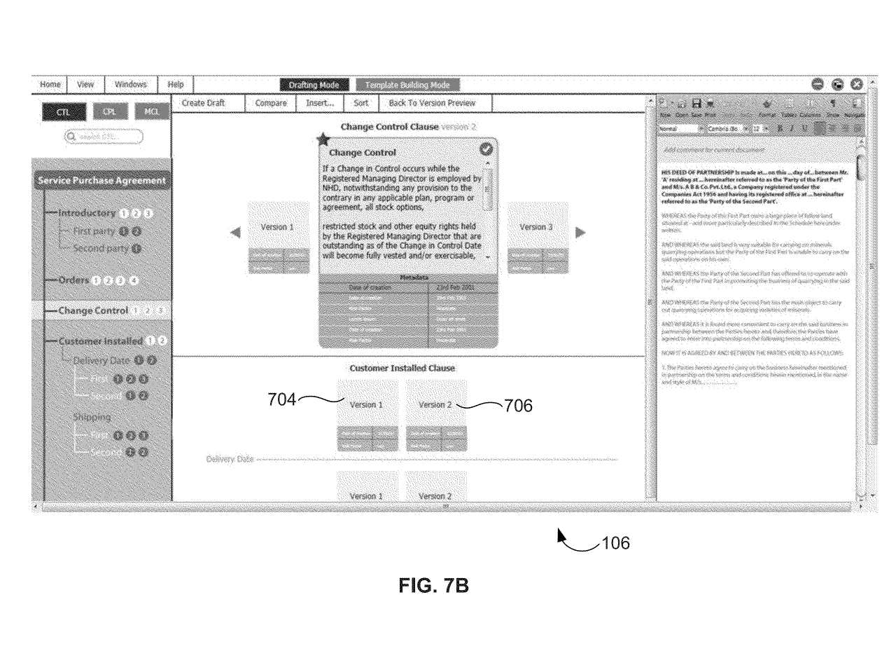

With reference to FIG. 5A through FIG. 6B, FIG. 7A illustrates a user interface view of the document creation tool 106 of FIG. 1 having only one version of clause 702 according to an embodiment herein. With reference to FIG. 5A through FIG. 7A, FIG. 7B illustrates a user interface view of the document creation tool 106 of FIG. 1 having only more than one alternative (e.g., competing) versions of clauses 704 and 706 according to an embodiment herein. The user 102 may use any of the alternative (e.g., competing) versions of clauses to build a template or a document for a specific type of service agreement. In one embodiment, the user 102 can select a sub-set of one or more alternative clauses and alternative sub-clauses from a set of one or more alternative clauses and alternative sub-clauses based on text and metadata of the sub-set of one or more alternative clauses and alternative sub-clauses as shown in FIG. 5A, and FIG. 5B.

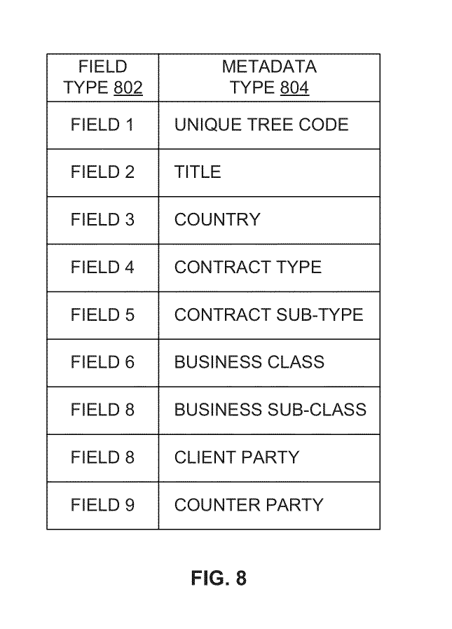

FIG. 8 is a table view illustrating type of metadata for a template tree according to an embodiment herein. The table view includes a field type 802, and a metadata type 804. The field type 802 includes various fields for corresponding metadata. The metadata type 804 includes various metadata for the template tree. The metadata type may be a unique tree code, a title, country, a contract type, a contract sub-type, a business class, a business sub-class, a client party, and/or a counter-party, etc.

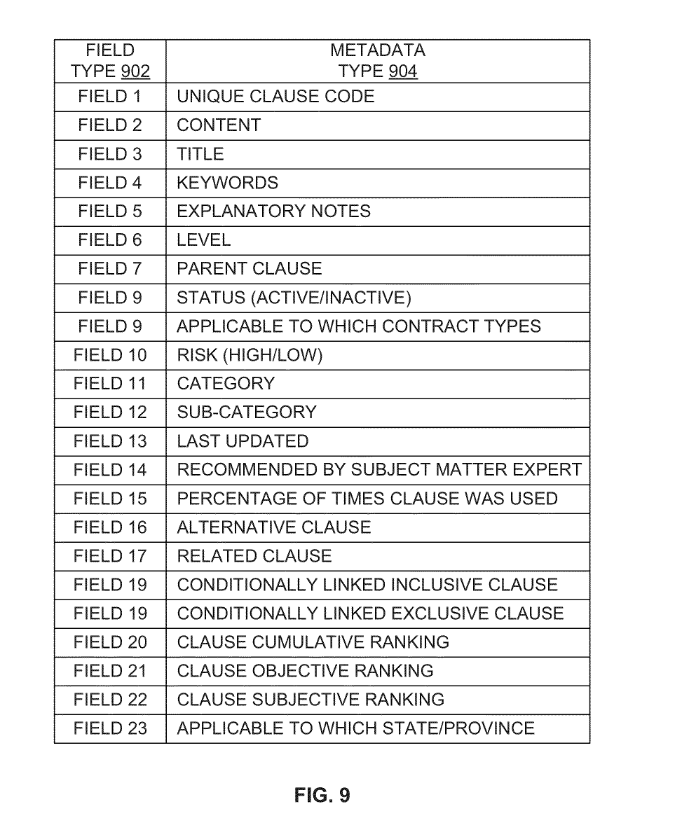

FIG. 9 is a table view illustrating type of metadata for alternative (e.g., competing versions) clauses, and alternative sub-clauses according to an embodiment herein. The table view includes a field type 902, and a metadata type 904. The field type 902 includes various fields for corresponding metadata. The metadata type 904 includes various metadata for the alternative (e.g., competing versions) clauses, and alternative sub-clauses. The metadata may be a unique clause code, content, a title, keywords, explanatory notes, a level, a parent clause, a status (active /inactive), applicable to which contract types, a risk level (high/low), a category, a sub-category, last updated, recommended by subject matter expert, percentage of times clause was used, alternative clauses, related clauses, conditionally linked inclusive clauses, conditionally linked exclusive clauses, clause cumulative rank, clause objective ranking, clause subjective ranking, and/or applicable to which State/Province, etc.

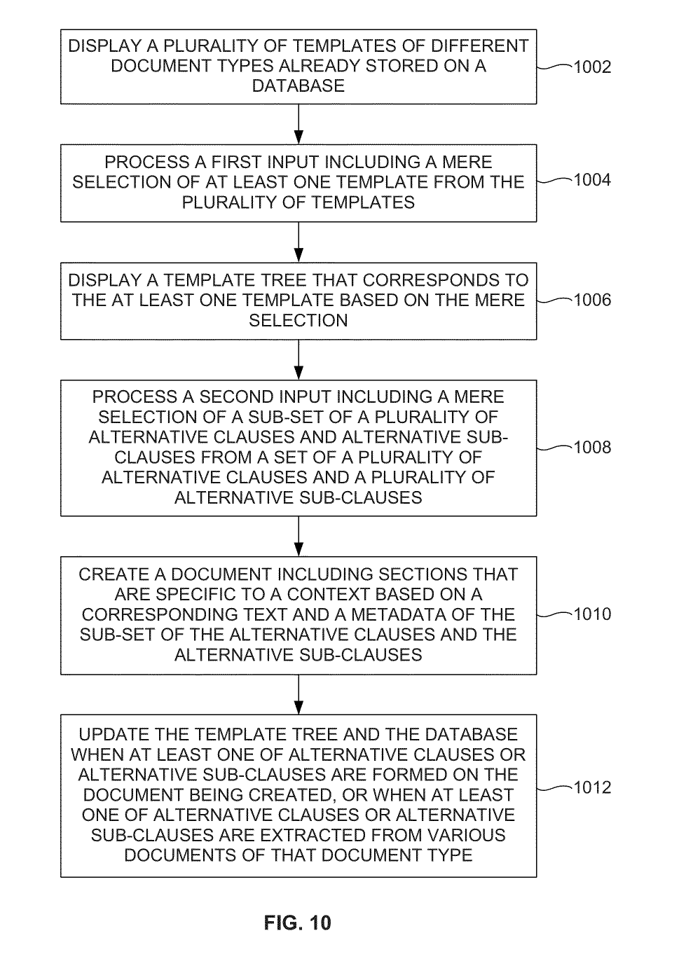

FIG. 10 is a flow diagram illustrating a method of dynamically creating at least one document of a specific document type using a document creation tool 106 of FIG. 1 according to an embodiment herein. The document that is created includes a plurality of sections that are specific to a context using a template tree of that document type without loss of relevant information while ensuring accuracy and standards to suit the context. The document creation tool 106 includes a database (e.g., the database 202 of FIG. 2) that store a plurality of templates of different document types. Each of the templates includes a set of a plurality of alternative clauses and a plurality of alternative sub-clauses that are arranged hierarchically.

In step 1002, a plurality of templates of different document types are displayed (e.g., using the display module 206 of FIG. 2). The templates are already stored on the database. In step 1004, a first input is processed (e.g., using the processing module 204 of FIG. 2) which is a mere selection of at least one template from the plurality of templates. In one embodiment, the template is a pre-defined template where the user 102 generates a document (using the document creation tool 106 of FIG. 1) without having to type text in it by using the existing alternative clauses and alternative sub-clauses. In step 1006, a template tree that corresponds to the template is displayed (e.g., using the display module 206 of FIG. 2) based on the mere selection. The template tree includes of a set of the plurality of alternative clauses and the plurality of alternative sub-clauses stored on the database. In step 1008, a second input is processed (e.g., using the processing module 204 of FIG. 2) which is a mere selection of a sub-set of a plurality of alternative clauses and alternative sub-clauses from the set of the plurality of alternative clauses and the plurality of alternative sub-clauses. The sub-set of the alternative clauses and the alternative sub-clauses are selected based on a corresponding text and metadata associated with the sub-set of the alternative clauses and the alternative sub-clauses. In step 1010, the document is created based on the corresponding text and the metadata of the sub-set of the alternative clauses and the alternative sub-clauses (e.g., using the document creation module of FIG. 2). The created document includes the sections that are specific to the context.

In step 1012, the template tree and the database are updated (e.g., using the update module 210 of FIG. 2) when at least one of alternative clauses, or alternative sub-clauses are formed on the document being created, or when at least one of alternative clauses or alternative sub-clauses are extracted from various documents of that document type. The metadata is a subjective qualification or an objective qualification of the text. The document is any of (i) a contract, (ii) agreements. The agreements may be any of a Non-disclosure agreement, a Service purchase agreement, a Goods purchase agreement, a Franchisee agreement, a Partnership agreement, or an Employee Union agreement, or any other document that is created using a precedent document of that document type or a predefined document that comprises of set of clauses or sub clauses.

The template tree for a particular document type includes text and metadata from various documents of that type and is segregated hierarchically such as a first level, a second level, and a third level. The second level is linked to the first level, and the third level is linked to the second level. Each of the alternative clauses, each of the alternative sub-clauses, or each of the sub-sub clauses serve as an alternate starting point for a user to draft a particular sections in the template tree of the document.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor. The embodiments herein can take the form of an entirely hardware embodiment, an entirely software embodiment or an embodiment including both hardware and software elements. The embodiments that are implemented in software include but are not limited to, firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

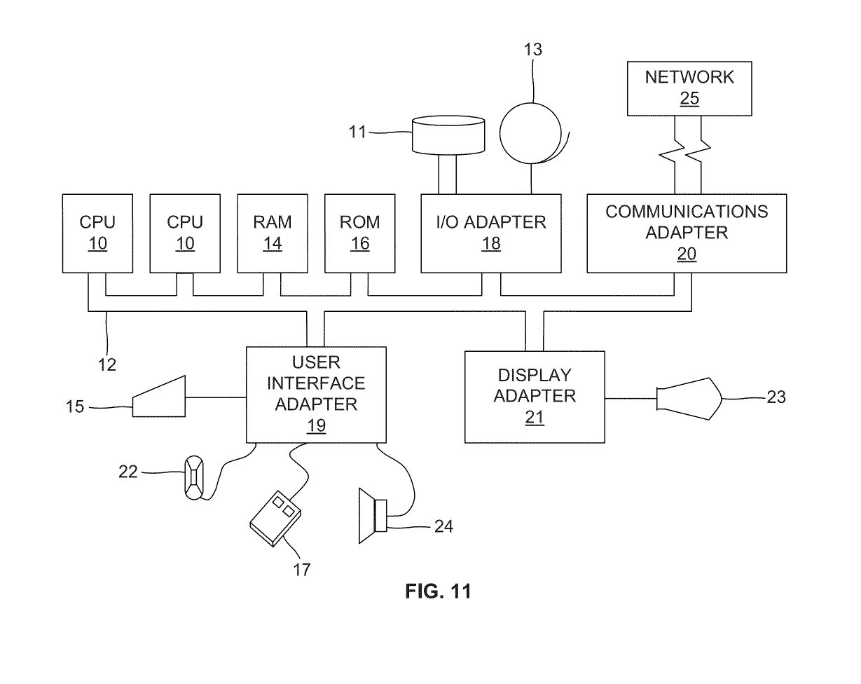

A representative hardware environment for practicing the embodiments herein is depicted in FIG. 11. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system.

The system can read the inventive instructions on the program storage devices and follow these instructions to execute the methodology of the embodiments herein. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The document creation tool 106 of FIG. 1 allows creating documents that are specific to a context using a template tree of that document type without loss of relevant information. This further ensures accuracy and standards by better construction of the document template to suit the current context. The document creation tool 106 further updates the template tree and the database 202 as and when new versions of one or more alternative clauses and/or sub-clauses are formed while creating the document for that document type. The template tree is extensive and consists of an exhaustive set of clauses and sub-clauses for a document type.

In addition, each clause or sub-clause will have several alternative versions, each of which may be relevant for a specific context. Hence the template tree of a document type will be an exhaustive set of possibilities of constructing a document. The template tree will keep on evolving into a more expansive tree when new versions of clauses and/or sub-clauses are formed in the course of creating documents of that document type and are added back to enrich the template tree. Thus, the document that is created includes one or more sections based on a corresponding text and metadata of a sub-set of the alternative clauses and the alternative sub-clauses that are selected from a plurality of the alternative clauses and the alternative sub-clauses.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method for generating a document of a specific document type that comprises a plurality of sections that are specific to a context using a template tree of said specific document type without loss of relevant information while ensuring accuracy and standards to suit said context, wherein said document is generated using a document creation tool that comprises:
a database that stores a plurality of templates of different document types, wherein each of said templates comprises a set of a plurality of alternative clauses and alternative sub-clauses that are arranged hierarchically, said method comprising:
displaying said plurality of templates of different document types already stored on said database;
processing a first input comprising a mere selection of at least one template from said plurality of templates;
displaying a template tree that corresponds to said at least one template based on said mere selection, wherein said template tree comprises a set of said plurality of alternative clauses and said plurality of alternative sub-clauses stored on said database;
processing a second input comprising a mere selection of a sub-set of alternative clauses and alternative sub-clauses from said set of said plurality of alternative clauses and said plurality of alternative sub-clauses, wherein said sub-set of said alternative clauses and said alternative sub-clauses are selected based on a corresponding text and metadata associated with said sub-set of said alternative clauses and said alternative sub-clauses; and
creating said document comprising said sections that are specific to said context based on said corresponding text and said metadata of said sub-set of said alternative clauses and said alternative sub-clauses.

2. The method of claim 1, wherein said method further comprises updating said template tree and said database
when at least one of alternative clauses or alternative sub-clauses are formed on said document being created, or
when at least one of alternative clauses or alternative sub-clauses are extracted from various documents of that document type.

3. The method of claim 1, wherein said metadata comprises a subjective qualification or an objective qualification of said text.

4. The method of claim 1, wherein said document is any of (i) a contract, (ii) an agreement, wherein said agreement is any of a Non-disclosure agreement, a Service purchase agreement, a Goods purchase agreement, a Franchisee agreement, a Partnership agreement, or an Employee Union agreement, or (iii) any other document that is created using (a) a precedent document of that document type or (b) a predefined document that comprises of set of clauses or sub-clauses.

5. The method of claim 4, wherein said template tree for a particular document type comprises text and metadata from various documents of that type, wherein said template tree is segregated hierarchically comprising a first level, a second level, and a third level, wherein said second level is linked to said first level, and said third level is linked to said second level.

6. The method of claim 1, wherein each of said alternative clauses, each of said alternative sub-clauses, or each of a plurality of sub-sub-clauses serves as an alternate starting point for said user to draft a particular section in said template tree of said document.

7. A document creation tool that dynamically generates a document that comprises a plurality of sections that are specific to a context using a template tree of that document type without loss of relevant information while ensuring accuracy and standards to suit said context, said document creation tool comprising:
a database that stores a plurality of templates of different document types, wherein each of said templates comprises a set of a plurality of alternative clauses and alternative sub-clauses that are arranged hierarchically;
a display module that displays said plurality of templates of different document types already stored on said database;
a processing module that processes:
a first input comprising a mere selection of at least one template from said plurality of templates, wherein a template tree that corresponds to said at least one template is displayed based on said mere selection, wherein said template tree comprises a set of said plurality of alternative clauses and said plurality of alternative sub-clauses stored on said database;
a second input comprising a mere selection of a sub-set of alternative clauses and alternative sub-clauses from said set of said plurality of alternative clauses and said plurality of alternative sub-clauses, wherein said sub-set of said alternative clauses and said alternative sub-clauses are selected based on corresponding text and metadata associated with said sub-set of said alternative clauses and said alternative sub-clauses; and
a document creation module that generates said document, said document comprising said sections that are specific to said context based on said corresponding text and said corresponding metadata of said sub-set of said alternative clauses and said alternative sub-clauses.

8. The document creation tool of claim 7, further comprises an update module that updates said template tree and said database when at least one of alternative clauses or alternative sub-clauses are formed on said document being created.

9. The document creation tool of claim 7, wherein said update module further updates said template tree and said database when at least one of alternative clauses or alternative sub-clauses are extracted from various documents of that document type.

10. The document creation tool of claim 7, wherein said template tree for a particular document type comprises said text from various documents of that type, wherein said template tree is segregated hierarchically comprising a first level, a second level, and a third level.

11. The document creation tool of claim 10, wherein said second level is linked to said first level, and said third level is linked to said second level.

12. The document creation tool of claim 7, wherein said metadata comprises a subjective qualification or an objective qualification of said text.

13. The document creation tool of claim 7, wherein said document is any of (i) a contract, (ii) an agreement, wherein said agreement comprises any of a Non-disclosure agreement, a Service purchase agreement, a Goods purchase agreement, a Franchisee agreement, a Partnership agreement, or an Employee Union agreement, or (iii) any other document that is created using (a) a precedent document of that document type or (b) a predefined document that comprises of set of clauses or sub-clauses.

14. A non-transitory program storage device readable by computer, and comprising a program of instructions executable by said computer to perform a method for generating a document of a specific document type that comprises a plurality of sections that are specific to a context using a template tree of said specific document type without loss of relevant information while ensuring accuracy and standards to suit said context, wherein said document is generated using a document creation tool that comprises:
a database that stores a plurality of templates of different document types, wherein each of said templates comprises a set of a plurality of alternative clauses and alternative sub-clauses that are arranged hierarchically, said method comprising:
displaying said plurality of templates of different document types already stored on said database;
processing a first input comprising a mere selection of at least one template from said plurality of templates;
displaying a template tree that corresponds to said at least one template based on said mere selection, wherein said template tree comprises a set of said plurality of alternative clauses and said plurality of alternative sub-clauses stored on said database;
processing a second input comprising a mere selection of a sub-set of alternative clauses and alternative sub-clauses from said set of said plurality of alternative clauses and said plurality of alternative sub-clauses, wherein said sub-set of said alternative clauses and said alternative sub-clauses are selected based on a corresponding text and metadata associated with said sub-set of said alternative clauses and said alternative sub-clauses; and
creating said document comprising said sections that are specific to said context based on said corresponding text and said metadata of said sub-set of said alternative clauses and said alternative sub-clauses.

15. The non-transitory program storage device of claim 14, wherein said method further comprises updating said template tree and said database when at least one of alternative clauses or alternative sub-clauses are formed on said document being created.

16. The non-transitory program storage device of claim 14, wherein said method further comprises updating said template tree and said database when at least one of alternative clauses or alternative sub-clauses are extracted from various documents of that document type.

17. The non-transitory program storage device of claim 14, wherein said template tree for a particular document type comprises said text from various documents of that type that is segregated hierarchically comprising a first level, a second level, and a third level.

18. The non-transitory program storage device of claim 17, wherein said second level is linked to said first level, and said third level is linked to said second level.

19. The non-transitory program storage device of claim 17, wherein said metadata comprises a subjective qualification or an objective qualification of said text.

20. The non-transitory program storage device of claim 17, wherein said document is any of (i) a contract, (ii) an agreement, wherein said agreement comprises any of a Non-disclosure agreement, a Service purchase agreement, a Goods purchase agreement, a Franchisee agreement, a Partnership agreement, or an Employee Union agreement, or (iii) any other document that is created using (a) a precedent document of that document type or (b) a predefined document that comprises of set of clauses or sub clauses.
